(19) United States
(12) Patent Application Publication
(10) Pub. No.: US 2010/0237202 A1
(43) Pub. Date: Sep. 23, 2010

(54) CARDBOARD SUPPORT INSERT FOR A LAWN AND GARDEN REFUSE BAG

(76) Inventor: Salvatore J. Minicozzi, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(21) Appl. No.: 12/793,497

(22) Filed: Jun. 3, 2010

Related U.S. Application Data
(63) Continuation-in-part of application No. 12/708,889, filed on Feb. 19, 2010.

(51) Int. Cl. B65B 67/12; B31B 1/26

(52) U.S. Cl. 248/97; 248/99; 493/162

(57) ABSTRACT

A flat, substantially square, or rectangular, insert with one or more vertical perforations, or fold lines, to facilitate folding for insertion into a soft-sided container such as a bag or a sack. The insert can include two stamped out areas for hand holds. The hand holds can be lined with handle liners for improved comfort and grip. The insert can be reusable, semi-reusable, or disposable depending on the materials used. The insert can include one or more bag retainers to further support the soft-sided container and prevent it from falling off of the insert. The insert may be sized and shaped to fit the inner dimensions of a variety of soft-sided containers for the purpose of providing the container with sufficient support to hold it in the fully open and usable position, preventing the container from collapsing during use.

### CROSS REFERENCE TO RELATED APPLICATION AND PRIORITY CLAIM

This application is a continuation-in-part of, claims priority to, and the benefit of, U.S. patent application Ser. No. 12/708,889, filed 19 Feb. 2010, which is incorporated herein by reference in its entirety as if fully set forth below.

### BACKGROUND OF THE INVENTION

1. Field of the Invention

The present invention relates generally to an insert useful for supporting various flexible containers to facilitate loading of the containers, and particularly to a folding, rigid, or semi-rigid, insert for supporting refuse, recycling, and lawn bags.

The present invention can be, for example and not limitation, a reusable cardboard insert that will support the structure and use of a standard size (e.g., 34″×16″×12″) lawn and garden refuse bag. The cardboard insert can be shaped to fit the inner dimensions of the lawn and garden refuse bag to facilitate keeping the lawn and garden refuse bag fully open and accessible to the user during loading.

2. Background of Related Art

It is desirable for persons to be able to collect refuse in a flexible container, such as a lawn and garden refuse bag, without the lawn and garden refuse bag(s) collapsing from an open usable position to a closed, unusable position and/or allowing a portion of the gathered refuse to fall outside the internal collection area of the lawn and garden refuse bag's storage area.

Flexible containers exist that are useful for collecting, carrying, storing and/or disposing of a variety of materials. Flexible containers can include sacks and bags comprising, for example and not limitation, burlap, cotton, plastic, PVC, and paper. Plastic bags, for example, are an omnipresent part of modern life and come in a variety of shapes and sizes and are made from myriad materials in a variety of thicknesses. Large plastic bags serve, for example, to line trash cans and other receptacles or can be used independently to gather trash, leaves, and other refuse.

Lawn refuse bags, rather than being made from plastic, are generally made from heavy duty wax coated paper and are useful for collecting and disposing of yard waste. These bags are particularly useful for disposing of biodegradable matter, such as yard waste, because like the yard waste the bags are compostable and recyclable. In this manner, the yard waste and the bags can be composted into mulch and recycled into the environment. This reduces demand on land fills and the use of artificial fertilizers by providing valuable natural nutrients to the soil.

Regardless of the size and material used, however, these flexible containers have a common shortcoming—they are not self-supporting. Even the stiff paper of the aforementioned lawn refuse bag tends to fold in on itself and/or be blown over or closed unless the bag is substantially full. This makes loading the bags difficult, frustrating, and time consuming. As a result, the user is generally required to attempt to hold the bag up and/or open with one hand and load the bag with the other. The user may enlist a helper to hold the bag while she loads; however, this is an inefficient use of resources, especially for the professional landscaper.

Conventionally, products that have attempted to address this problem have tended to be permanent fixtures. For example, the Lawn Funnel by Young Manufacturing is a large plastic funnel that fits into a lawn refuse bag. The funnel acts to hold the bag open and provide a funnel at the top to facilitate loading the bag. Unfortunately, due to its rigid plastic construction, the funnel requires excessive storage space when not in use. This is problematic, in areas such as the garage or garden shed, where storage is generally at a premium.

Another common example is the Port-A-Sac® lawn bag stand. The Port-A-Sac® is a folding stand over which plastic lawn bags can be folded and supported. The stand is manufactured from steel rods bent to form two substantially rectangular halves that are pinned together to form a stand. The stand can be opened to accommodate a bag and is free standing. Due to its steel construction, however, the stand is both fairly heavy and rust prone. In addition, because the bag is folded over the top of the stand, it is unsuitable for use with paper lawn refuse bags, which tend to rip at the corners if the top of the bag is folded over.

What is needed, therefore, is an economical, user-friendly solution to this ubiquitous problem that can be sized for use with a variety of bags and bag materials. What is needed is a structurally stabilizing insert to hold the lawn and garden refuse bag in the full and open position allowing greatest access to the internal storage area. It is to such an invention that embodiments of the present invention are primarily directed.

### BRIEF SUMMARY OF THE INVENTION

Embodiments of the present invention relate generally to an insert for supporting a variety of flexible containers, and specifically to a rigid, or semi-rigid, insert for supporting lawn and garden, trash, and recycling bags. The invention can comprise, for example and not limitation, cardboard, paperboard, or plastic. The invention is described with reference to its ability to be folded along creased or perforated lines.

The present invention provides for an insert comprising a flat substantially rectangular piece of material, such as cardboard, with overall dimensions suitable to support a flexible container, e.g., a paper lawn and garden refuse bag. For a standard paper lawn and garden refuse bag the insert can preferably be 36″×32″×¼″ and can be stamped and perforated according to the drawings provided. The invention can be made of, for example, 69 pound weighted corrugated cardboard; although other weights, types of cardboard or paperboard, and other materials are contemplated.

The insert can comprise one or more handles. In some embodiments, the handles can further comprise handle inserts that can make the handles more comfortable for the user. In some embodiments, the insert can further comprise one or more bag retainers. The bag retainers can enable the bag being supported to be pushed through the retainer and retained to prevent the bag from pulling off the insert during loading.

### BRIEF DESCRIPTION OF THE DRAWINGS

FIG. 1 illustrates a front view of an insert for flexible containers, in accordance with some embodiments of the present invention.

FIG. 2 illustrates a top view of the insert in FIG. 1, in accordance with some embodiments of the present invention.

FIG. 3 illustrates a top view of the insert in FIG. 1 with one wing portion folded, in accordance with some embodiments of the present invention.

FIG. 4 illustrates a top view of the insert in FIG. 1 with both wing portions folded, in accordance with some embodiments of the present invention.

FIG. 5 illustrates a top view of the insert in FIG. 1 with both wing portions in their deployed position, in accordance with some embodiments of the present invention.

FIG. 6 illustrates a perspective view of the insert in FIG. 1 with both wing portions in their deployed position, in accordance with some embodiments of the present invention.

FIG. 7 illustrates a perspective view of the insert in FIG. 1 inserted into a flexible container, in accordance with some embodiments of the present invention.

FIG. 8 illustrates a front view of a bag retainer, in accordance with some embodiments of the present invention.

FIGS. 9a and 9b illustrate a side view of the bag retainer in FIG. 8 with a bag inserted in the retainer, in accordance with some embodiments of the present invention.

FIG. 10 illustrates a perspective view of a handle liner for use with the insert in FIG. 1, in accordance with some embodiments of the present invention.

### DETAILED DESCRIPTION OF THE INVENTION

Embodiments of the present invention relate generally to a system and device for supporting and holding open a variety of soft-sided containers, and specifically to a folding, rigid, or semi-rigid, insert for holding open trash or lawn bags to facilitate loading. The system can comprise a rigid, or semi-rigid, piece of sheet material that is, for example, perforated or creased to form three distinct sections. The system can be placed inside a flexible container, such as a plastic trash bag, and unfolded thereby forming an internal support for the container. This enables the container to remain upright and open to facilitate loading. When the container is full, the device can be removed, or can be discarded along with the container.

To simplify and clarify explanation, the system is described below as a system for use with paper lawn refuse bags and plastic trash bags (“bags”). One skilled in the art will recognize, however, that the invention is not so limited. The system can also be deployed to support a variety of other soft-sided containers including, but not limited to, plastic shopping bags, canvas totes and duffle bags, and laundry bags. Embodiments of the present invention can also be used, for example, to provide support for construction totes and Flexible Intermediate Bulk Containers (FIBCs).

The materials described hereinafter as making up the various elements of the present invention are intended to be illustrative and not restrictive. Although cardboard is used for many purposes in our everyday lives, there is (are) no specific use(s) of cardboard for the purpose of rendering lawn and garden refuse bags fully open, accessible and usable in the initial stages of its storage use. Nonetheless, many suitable materials that would perform the same or a similar function as the materials described herein are intended to be embraced within the scope of the invention. Such other materials not described herein can include, but are not limited to, materials that are developed after the time of the development of the invention, for example. The dimensions listed in the various drawings are for illustrative purposes only and are not intended to be limiting. Other dimensions and proportions are contemplated and intended to be included within the scope of the invention.

A problem with conventional bag support products is that they can be bulky, heavy, and difficult to store. In addition, while some bag support products work well enough for their intended purpose, they are relatively narrow in focus. The Port-A-Sac® lawn bag stand, for example, is suitable only for supporting bags with sufficient flexibility to be folded over the top of the sides of the stand. This design is not suitable for less flexible bag styles, like paper lawn refuse bags.

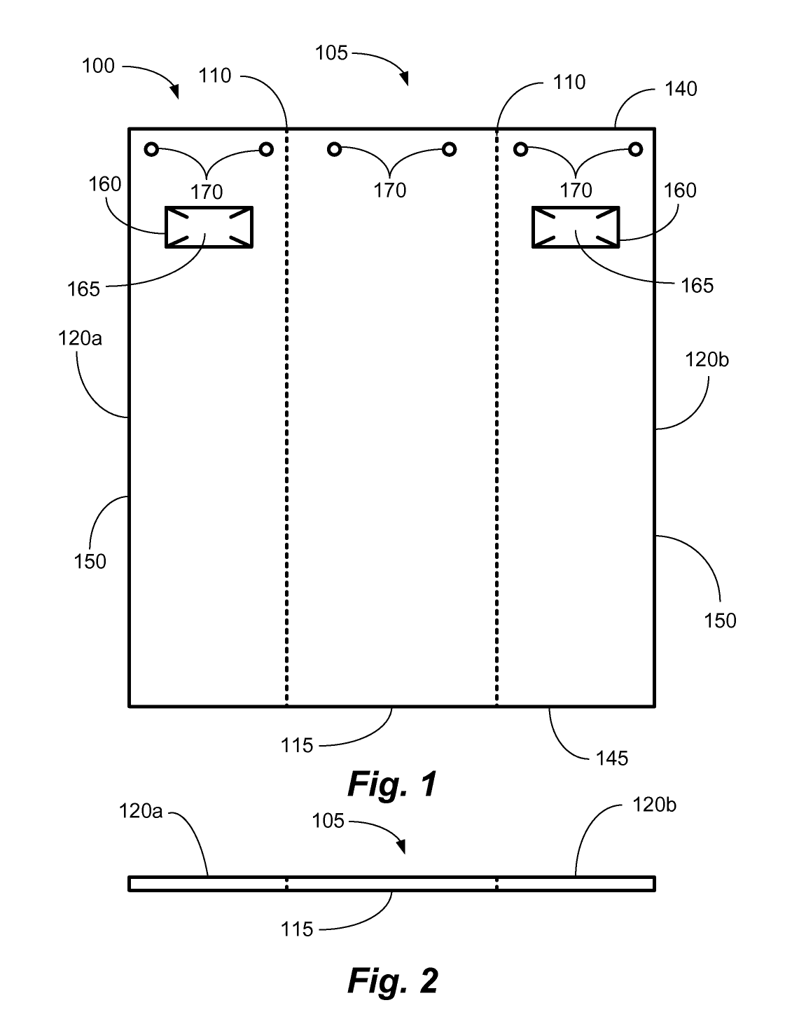

As shown in FIGS. 1 and 2, embodiments of the present invention relate to a system and device for supporting and holding open a bag to facilitate loading. The device 100 can comprise a rigid, or semi-rigid, piece of flat stock or card stock material that forms the main body 105 of the device 100. A disposable embodiment of the main body 105 can comprise, for example and not limitation, cardboard, paperboard, or cardstock. In some embodiments, the main body 105 can comprise, for example and not limitation, wood, plastic, vinyl, or Plexiglas®, to provide a more permanent product. In a preferred embodiment, the main body 105 can comprise corrugated cardboard. The cardboard can be stamped or cut to a variety of sizes and shapes and can include a number of additional features.

In some embodiments, the main body 105 can comprise one or more fold lines 110. Depending on the material used, the fold lines 110 can be created in a variety of ways. The fold lines 110 can be, for example, folded, creased, or melted into the main body 105 of the device 100. In some embodiments, for example, the main body 105 can comprise plastic and the fold lines 110 can be made using a heated folding iron. In this manner, the plastic has a natural hinging effect at the fold lines 110 enabling it to be more easily shaped. In a preferred embodiment, the main body 105 can comprise corrugated cardboard that is perforated along the fold lines 110.

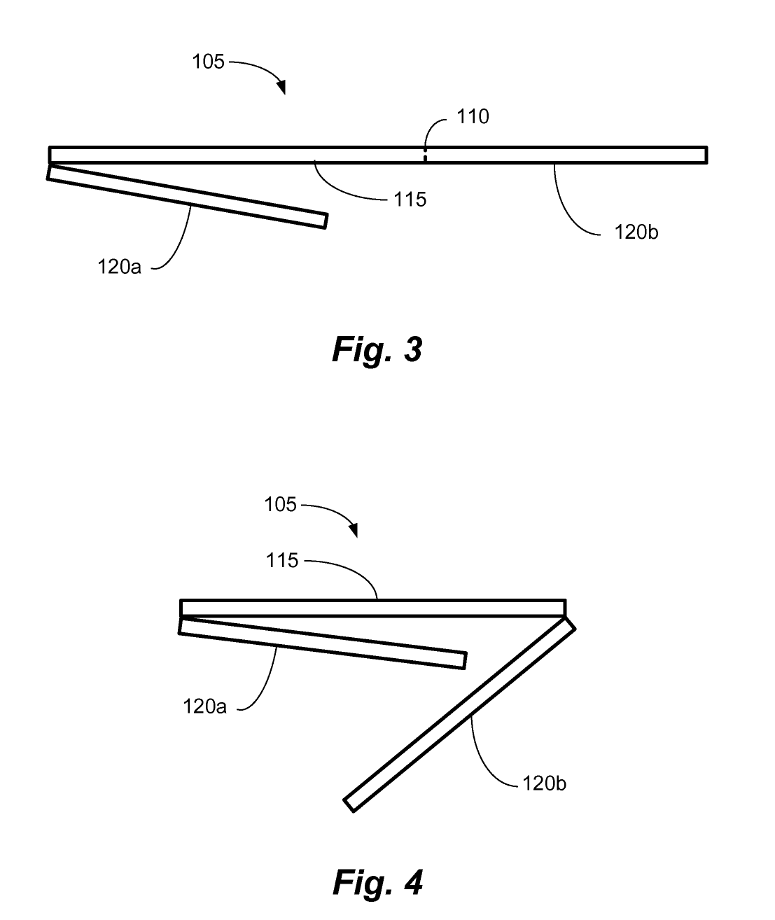

As shown in FIGS. 3 and 4, regardless of the method used for creating the fold lines 110, the fold lines 110 can divide the main body 105 into a center section 115, and two wing sections 120a, 120b, or leafs. The fold lines 110 can enable the wing sections 120a, 120b to be folded in over the center section 115. In this configuration, the cross section of the insert 100 is reduced to enable it to be inserted into the bag.

In some embodiments, the insert can comprise corrugated cardboard. Cardboard can enable the insert to be sufficiently stiff, yet inexpensive enough to be disposable. In this configuration the insert can be used one or more times and then discarded in the bag it previously supported. In some embodiments, the perforations forming the fold lines 110 can penetrate only the top layer of the cardboard to enable the cardboard to be easily folded, yet prevent the side panels 120a, 120b from becoming detached from the center section 115.

In some embodiments, the insert 100 could comprise a substantially rigid material, such as plywood. In this configuration, the center section 115 and the wing sections 120a, 120b can be hingeably coupled. In other words, when using a rigid material, the fold lines 110 can comprise, for example and not limitation, hinges, pins, or flexible straps. In this configuration, the insert 100 can represent a relatively permanent solution and can be used repeatedly.

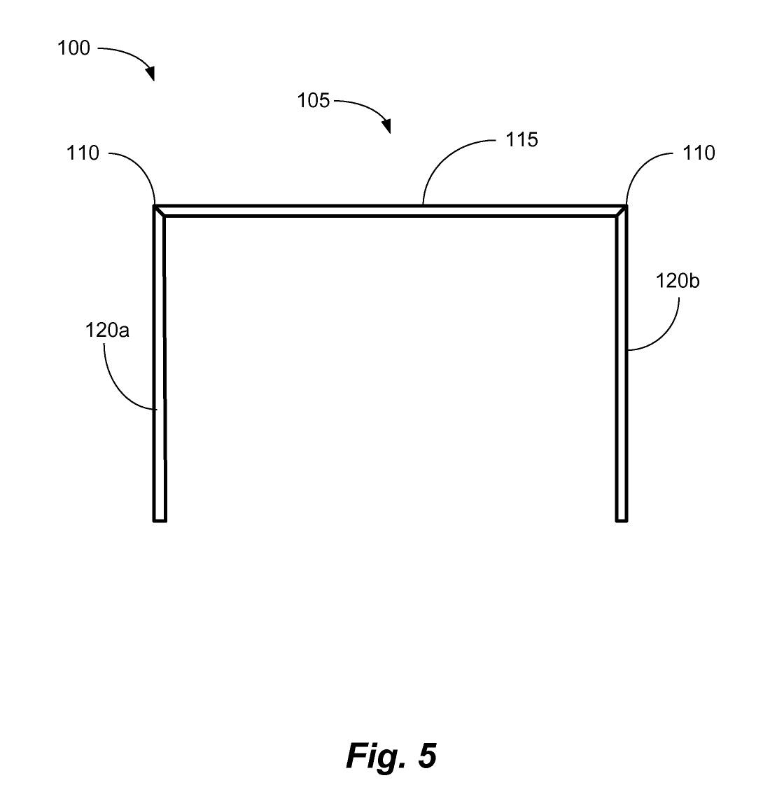

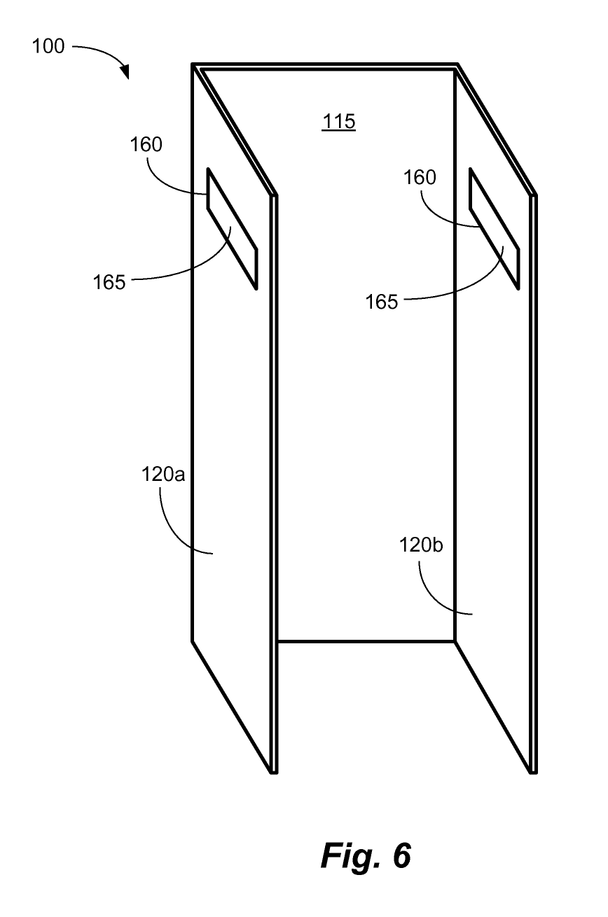

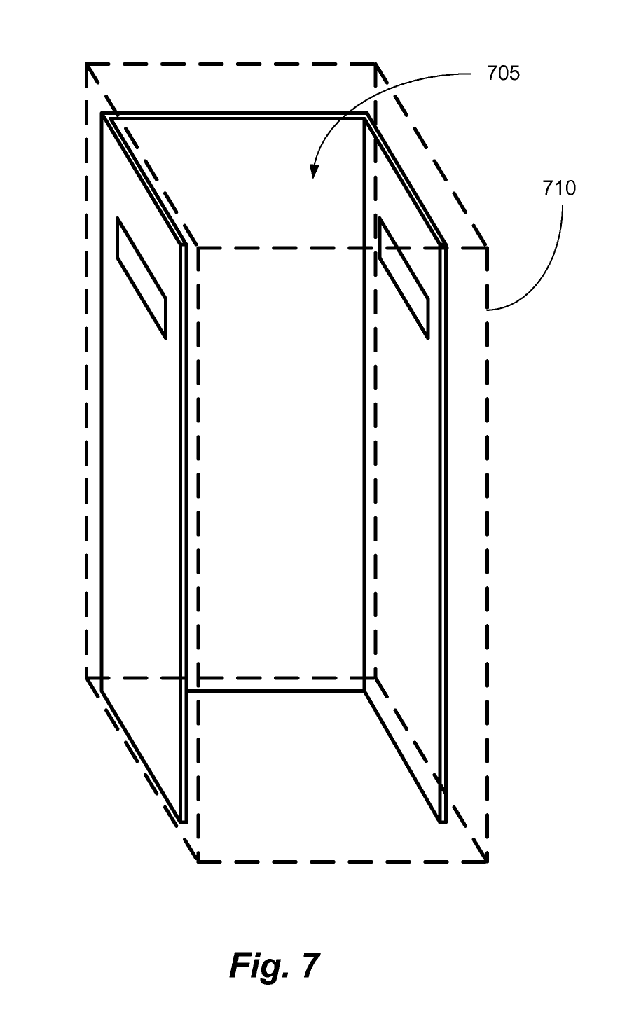

As shown in FIGS. 5 and 6, when deployed the insert 100 can comprise a substantially u-shaped cross section. This cross section enables the insert 100 to be relatively sturdy and resistant to bending from objects hitting it, or weighing upon it, as they are inserted into the bag. As shown in FIG. 7, this configuration also enables the insert 100 to stand upright and to support the bag 710 (shown in dashed lines) in an upright and open position. This enables the user to easily load the bag 710 without the bag 710 falling over, collapsing, or closing. This, in turn, improves efficiency, and reduces loading time and frustration.

In use, the insert 100 can be folded, as shown in FIG. 4 for example, to enable it to be easily inserted into the bag 710 to be supported. Folding the wings sections 120a, 120b inward greatly reduces the width of the insert 100 to facilitate placing the insert inside the bag 710. The insert 100 can be placed to the bottom of the bag 710 and the wing sections 120a, 120b can be unfolded such that the wing sections 120a, 120b are substantially perpendicular to the center section 115. The u-shaped planform also enables the insert 100, and the bag 710, to stand upright. In this manner, the insert 100 both supports the bag 710 and holds the bag 710 open creating the loading area 705.

The loading area 705 enables the user to quickly and easily fill the bag 710. In some embodiments, when the capacity of the bag 710 is reached, the user can remove the insert 100, seal the bag 710, and move on to the next bag with the same insert 100. In other embodiments, the insert 100 can be disposable, and the user can simply seal the bag 710 and move on to the next bag with a new insert. In still other embodiments, the insert 100 can be semi-disposable. In other words, the insert 100 can be durable enough for multiple uses, yet be ultimately disposable, e.g., at the end of the day.

The material chosen for the insert 100 is largely responsible for the durability of the insert 100. For example, an insert 100 comprising plywood panels hingeably coupled to each other with piano hinges would be substantially permanent, but would be comparatively heavy and expensive. An insert 100 comprising cardboard with perforations, on the other hand, would be extremely lightweight and inexpensive, but may only be durable enough for one or two uses.

In some embodiments, the insert 100 can comprise a relatively inexpensive material such as, for example, corrugated cardboard, and can be sold in bundles with various types of bags. So, for example, the insert 100 could be sold in bundles along with bundles of paper lawn refuse bags, which are often sold in bundles of five. In this manner, the user could purchase five bags and five inserts at the same time. Each time the user fills a bag, he simply reaches for another bag and another insert 100. In this manner, the user can simply dispose of the insert with the bag. In other embodiments, appropriately sized inserts 100 could also be sold for use with, for example and not limitation, plastic lawn and leaf bags, standard trash bags, and contractors' bags.

Referring back to FIG. 1, in some embodiments, the insert 100 can further comprise one or more handles 160. The handles 160 can enable the insert 100 to be more easily handled and maneuvered by the user. The handles 160 can be a perforated area on the wing sections 120a, 120b of the insert 100. In some embodiments, the handles 160 can be perforated on three sides enabling a flap 165 to be folded inside or outside the insert 100. The flap 165 can increase the thickness of the insert 100 in the area of the handles 160 providing a more comfortable grip. In other embodiments, the handles 160 can be perforated around its perimeter enabling the flap 165 to be removed from the insert 100, thus creating a hand hold 160. When used with a soft container, such as a plastic trash bag for example, the bag can be pushed through the hand hold 160 enabling the user to pick up the bag and the insert at the same time.

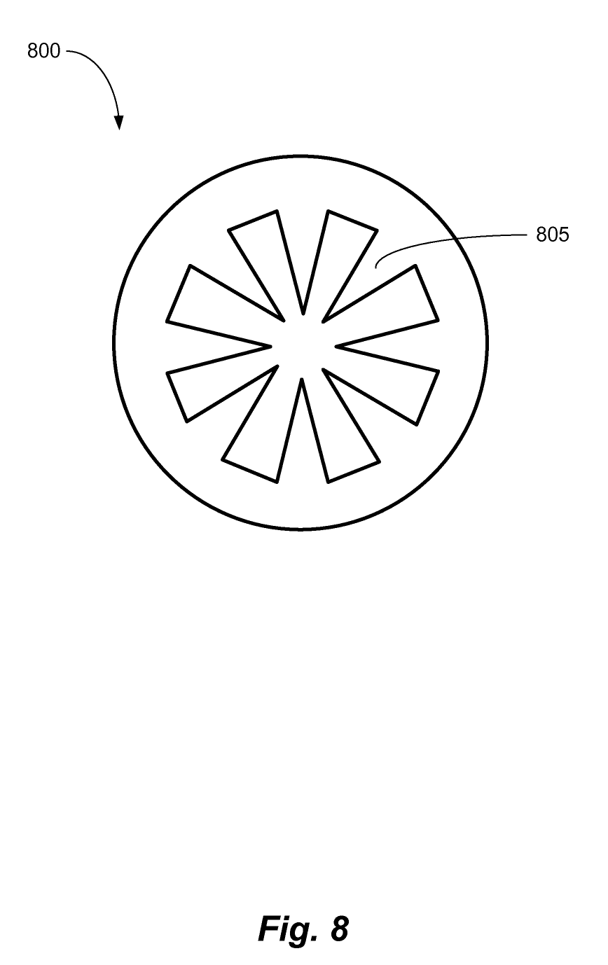

As shown in FIG. 8, in some embodiments, the insert 100 can further comprise one or more bag retainers 800. The bag retainers 800 can be a small insert comprising, but not limited to, nylon or plastic with multiple finger-like projections 805. The retainer 800 can be inserted into holes 170 punched or perforated into the main body 105 of the insert 100 during manufacture. See, FIG. 1. The projections 805 can be somewhat flexible such that, when pressed on, they tend to bend inward or outward.

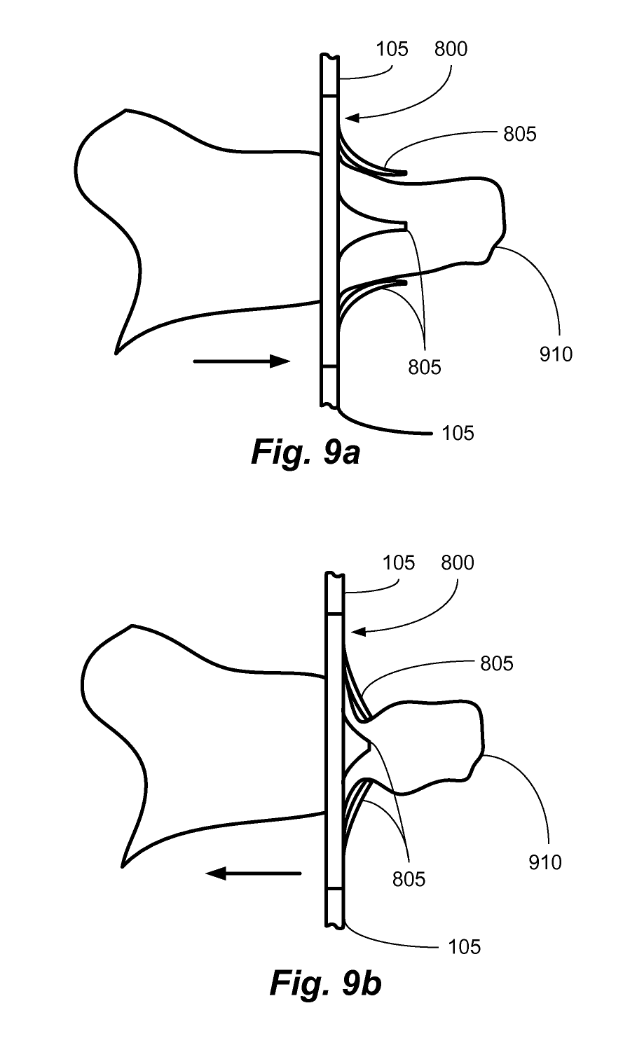

As shown in FIG. 9a, when the insert 100 is used with a flexible container, such as a plastic trash bag 910, the bag 910 can be pushed through the retainer 800, pushing the projections 805 in a first direction. As shown in FIG. 9b, if tension is then placed on the bag 910 that would tend to pull the bag 910 out of the insert 100, the projections 805 are pulled straight, or nearly straight, trapping the bag 910 in the insert 100. This can prevent the bag 910 from pulling out of the insert 100 as the bag 910 is loaded.

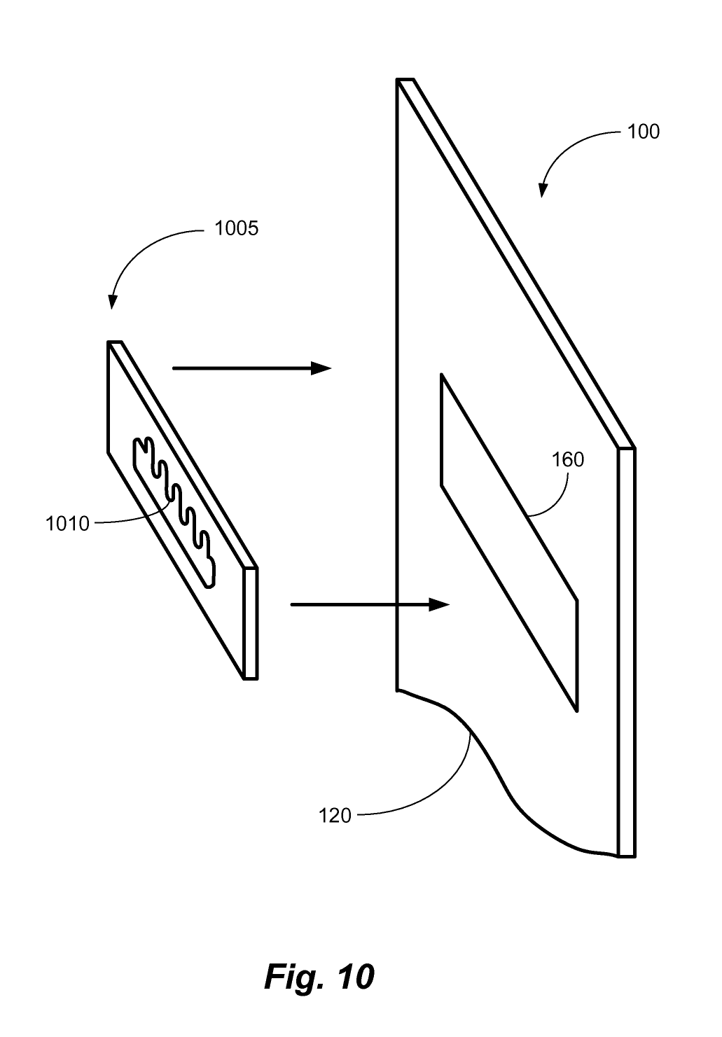

As shown in FIG. 10, in some embodiments, the insert 100 can further comprise a separate handle liner 1005. The handle liner 1005 can comprise, for example and not limitation, plastic, nylon, cardboard, or paperboard. In some embodiments, for example, the flap 165 can be removed from the insert 100 and a handle liner 1005 placed in the hand hold 160. The handle liner 1005 can be smooth and provide a wider, more comfortable surface for holding and lifting the insert 100. As shown in FIG. 10, in some embodiments, the handle liner 1005 can have finger indentations 1010 for increased comfort. In some embodiments, the handle liner 1005 can be disposable and can be discarded with the insert 100. In other embodiments, the handle liner 1005 can be reusable and can be transferred from one insert 100 to the next.

### Example 1

The insert 100 can be sized and shaped for use with a variety of different bags. Embodiments of the present invention can, for example, be cut, sized, perforated and stamped for the purpose of folding the insert—thus giving the insert the ability to be shaped—to fit the interior dimensions of a standard 34″×16″×12″ lawn and garden refuse bag. A purpose of this invention is to give structural support to the lawn and garden refuse bag while the lawn and garden refuse bag is being used and utilized in the collection and accumulation of refuse.

The insert 100 can be made of, for example and not limitation, 69 pound weight corrugated cardboard (although cardboard or paperboard of other weight and material may also be substituted.) The overall dimensions of the insert 100 when unfolded can be approximately 36″ wide×32″ tall×½″ thick.

As mentioned above, the insert 100 can contain one or more perforations, or fold lines 110, to its rear outer layer allowing for bending, molding, and shaping of the insert 100 to fit the interior dimensions of a standard 34″×16″×12″ lawn and garden refuse bag. The perforations 110 are both approximately 32″ perforated runs substantially vertically from the top horizontal edge 140 to the bottom horizontal edge 145. In some embodiments, the perforations 110 can be approximately 10.5″ from, and parallel to, the vertical edges 150. These perforations 110 can segment the insert into three distinct regions or areas of the insert 100, i.e., the center section 115 and the two side sections 120a, 120b. The side sections 120a, 120b can be approximately 10.5″×32.″ The center section 115, or the area between the perforations 110, can be approximately 15″×32″. In a preferred embodiment, the perforations 110 do not cut through the insert 100 completely; rather they score the rear outer layer of the corrugated cardboard thereby allowing bending, molding and shaping of the insert 100 without causing detachment of the two side sections 120a, 120b.

As best shown in FIGS. 3, 4, and 5, the insert 100 can be bent, molded, or shaped in a variety of ways. FIG. 4 best illustrates the insert 100 fully folded to be initially inserted into the lawn and garden refuse bag. As depicted in FIGS. 6 and 7, the insert 100 is fully deployed and is in its intended use position, i.e., for providing stability and structure to the lawn and garden refuse bag.

In this example, the insert 100 can have two stamped out areas 160. The stamped out areas 160 are portions of the corrugated cardboard insert 100 that have been fully cut through one, or both, of front and rear outer layers of the insert 100 and removed, or folded back, from the main body 105 of the insert 100. As mentioned, the purpose of the stamped out areas 160 is to serve as hand holds for the ease of moving, folding, carrying, removing or in general handling the insert 100 whether during use or in storing the insert 100. The stamped out areas 160 can be located on both the left leaf 120a and the right leaf 120b (e.g., one stamped out area per leaf 120a and 120b, though other configurations are contemplated). The positioning of the stamped out areas 160 can be, for example, approximately 2″×5.5″. The areas 160 can be positioned approximately 3″ from the top edge 140 of the insert 100 and about 8″ outboard of their respective fold lines 110 (i.e., approximately 8″ from the vertical edges 150 of the insert 100).

### Example 2

As mentioned, the insert 100 can be sized and shaped for use with a variety of different bags. Embodiments of the present invention can, for example, be cut, sized, perforated and stamped for the purpose of folding it—thus giving it the ability to be shaped—to fit the interior dimensions of a standard 39 gallon plastic contractor's clean-up bag. A purpose of this invention is to give structural support to the clean-up bag while the clean-up bag is being used and utilized in the collection and accumulation of refuse.

The insert 100 can be made of, for example and not limitation, high-density polyethylene (although other materials may also be substituted.) The overall dimensions of the insert 100 when unfolded can be approximately 48″ wide×43″ tall.

As mentioned above, the insert 100 contains one or more fold lines 110, to allow for bending, molding, and shaping of the insert 100 to fit the interior dimensions of a standard 39 gallon plastic bag. The fold lines 110 are both approximately 43″molded or melted lines in the polyethylene and are substantially vertically from the top horizontal edge 140 to the bottom horizontal edge 145. In some embodiments, the fold lines 110 can be approximately 16″ from, and parallel to, the vertical edges 150. These fold lines 110 can segment the insert into three distinct regions or areas of the insert 100, i.e., the center section 115 and the two side sections 120a, 120b. The side sections 120a, 120b can be approximately 16″×42.″ The center section 115, or the area between the perforations 110, can be approximately 16″×42″. The fold lines 110 do not cut through the insert 100 completely; rather they score or dimple the polyethylene allowing bending, molding, and shaping of the insert 100 without causing detachment of the two side sections 120a, 120b.

As best shown in FIGS. 3, 4, and 5, the insert 100 can be bent, molded, or shaped in a variety of ways. FIG. 4 best illustrates the insert 100 fully folded to be initially inserted into the plastic bag. As depicted in FIGS. 6 and 7, the insert 100 is fully deployed and is in its intended use position, i.e., for providing stability and structure to the plastic bag.

In this example, the insert 100 can have two stamped out areas 160. The stamped out areas 160 are portions of the polyethylene insert 100 that have been fully cut through the insert 100 and removed, or folded back, from the main body 105 of the insert 100. As mentioned, the purpose of the stamped out areas 160 is to serve as hand holds for the ease of moving, folding, carrying, removing or, in general, handling the insert 100 whether during use or in storing the insert 100. The stamped out areas 160 can be located on the left leaf 120a, the right leaf 120b, and the main body 105 (e.g., one stamped out area per leaf 120a, 120b and/or main body 105, though other configurations are contemplated). The positioning of the stamped out areas 160 can be, for example, approximately 2″×5.5″. The areas 160 can be positioned approximately 3″ from the top edge 140 of the insert 100 and about 8″ outboard of their respective fold lines 110 (i.e., approximately 8″ from the vertical edges 150 of the insert 100), though other positions are contemplated.

While several possible embodiments are disclosed above, embodiments of the present invention are not so limited. For instance, while several possible configurations of materials for the insert have been disclosed, other suitable materials and combinations of materials could be selected without departing from the spirit of embodiments of the invention. In addition, the location and configuration used for various features of embodiments of the present invention can be varied according to a particular container or bag design that requires a slight variation due to, for example, the size or construction of the bag. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. An insert comprising:
a main body;
a right leaf pivotally coupled to the main body;
a left leaf pivotally coupled to the main body;
wherein the right leaf and the left leaf can be positioned at a non-parallel angle to the main body to form an interior cavity therebetween; and
wherein the insert is sized and shaped to substantially occupy the interior of a flexible container to hold the flexible container in an open position to facilitate the loading of the flexible container.

2. The insert of claim 1, wherein
the main body, right leaf, and left leaf are manufactured from a single piece of corrugated cardboard; and
the right leaf and the left leaf are formed by perforations in the corrugated cardboard to facilitate folding of the right and left leaf inward with respect to the main body.

3. The insert of claim 1, wherein the insert is sized and shaped to support a standard paper lawn and garden refuse bag.

4. The insert of claim 1, wherein the flexible container comprises a plastic refuse bag with a capacity of between approximately 5 to 55 gallons.

5. The insert of claim 4, wherein the flexible container comprises a plastic refuse bag with a capacity of between approximately 30 to 45 gallons.

6. The insert of claim 1, wherein
the main body, right leaf, and left leaf are manufactured from a single piece of plastic; and
the right leaf and the left leaf are formed by fold lines molded into the plastic to facilitate folding of the right and left leaf inward with respect to the main body.

7. The insert of claim 1, wherein
a top portion of one or more of the right leaf, the left leaf, and the main body further comprise one or more cutouts;
wherein one or more of the cutouts are removed to serve as handholds for the insert.

8. The insert of claim 1, wherein
a top portion of one or more of the right leaf, the left leaf, and the main body further comprise one or more perforated portions;
wherein the one or more of the perforated portions are folded over the insert to serve as handholds for the insert.

9. An insert comprising:
a main body with a first surface, a second surface, a right side, and a left side;
a right leaf, with a first surface, a second surface, a right side and a left side, the left side of the right leaf pivotally coupled to the right side of the central portion; and
a left leaf, with a first surface, a second surface, a right side and a left side, the right side of the left leaf pivotally coupled to the left side of the central portion; and
one or more cutouts for providing handholds on the insert;
wherein the right leaf and the left leaf are configured to be disposed at a non-parallel angle with respect to the main body such that the first surfaces of the right leaf, the left leaf, and the main body define an interior area for the placement of refuse;
wherein the insert is sized and shaped to provide support for a flexible storage container to hold the flexible storage container in an open and upright position to facilitate the loading thereof; and
wherein the one or more cutouts are disposed on a top portion of one or more of the right leaf, the left leaf, and the main body.

10. The insert of claim 9, wherein
the main body, right leaf, and left leaf are manufactured from a single piece of coated paper; and
the right leaf and the left leaf are formed by fold lines formed in the coated paper to facilitate folding of the right and left leaf with respect to the main body.

11. The insert of claim 9, wherein the flexible storage container is a plastic trash bag.

12. The insert of claim 9, wherein the flexible storage container is a paper lawn refuse bag.

13. A method of manufacturing an insert comprising:
providing a piece of flat sheet stock with a left edge, right edge, and a top edge;
forming a first crease line in the sheet stock substantially parallel to the left edge and disposed between the left edge and the middle of the sheet stock;
forming a second crease line in the sheet stock substantially parallel to the right edge, disposed between the right edge and the middle of the sheet stock, and spaced apart from the first crease line to form a right wing portion, a middle portion, and a left wing portion on the piece of flat sheet stock; and
perforating one or more portions of the sheet stock disposed proximate to the top edge to provide one or more handles for the insert.

14. The method of manufacture of claim 13, wherein
the sheet stock comprises corrugated cardboard; and
the first and second crease lines are formed by perforating the cardboard.

15. The method of manufacture of claim 13, wherein
the sheet stock comprises plastic; and
the first and second crease lines are molded into the plastic.

16. The method of manufacture of claim 13, wherein
the sheet stock comprises coated paper; and
the first and second crease lines are pressed into the coated paper using a hydraulic press.

17. The method of manufacture of claim 13, wherein
the sheet stock comprises plastic; and
the first and second crease lines are melted into the plastic using a hot iron.

18. The method of manufacture of claim 13, further comprising:
creating one or more holes proximate the top edge of the insert;
inserting one or more bag retainers into the one or more holes.

19. The method of manufacture of claim 13, further comprising:
removing the one or more perforated portions disposed proximate the top edge to form a hand hold; and
inserting a handle liner into the hand hold.
